(19) United States
(12) Patent Application Publication
(10) Pub. No.: US 2026/0104824 A1
(43) Pub. Date: Apr. 16, 2026

(54) Method And Device For Reducing Write Amplification Of Storage Apparatus

(71) Applicant: Samsung Electronics Co., Ltd., Suwon-si (KR)

(72) Inventors: Kuan GAO, Xi'an (KR); Qijie SUN, Xi'an (KR); Chao LIN, Xi'An (CN)

(73) Assignee: Samsung Electronics Co., Ltd., Suwon-si (KR)

(21) Appl. No.: 18/929,771

(22) Filed: Oct. 29, 2024

(30) Foreign Application Priority Data
Oct. 10, 2024 (CN) 202411412094.3

(51) Int. Cl. G06F 3/06

(52) U.S. Cl. CPC G06F 3/0659; G06F 3/0619; G06F 3/0679

(57) ABSTRACT

There is provided methods and devices for reducing write amplification of a storage apparatus, including monitoring a running status of at least one application; acquiring historical write data of a first application from an application history record to estimate a storage space for current foreground running of the first application based on monitoring the running status of the first application among the at least one application switching to foreground running; determining a storage apparatus adjustment command based on the estimated storage space for the current foreground running of the first application, the storage apparatus including a high-speed storage portion and a low-speed storage portion, the storage apparatus adjustment command including adjustments to a storage space of a variable area in the high-speed storage portion, and the storage apparatus configured to store data generated in response to the at least one application running in the variable area.

This U.S. non-provisional application claims the benefit of priority under 35 U.S.C. 119 from Chinese Patent Application No. 202411412094.3, filed on Oct. 10, 2024 in the TBD Chinese Property Office, the entire contents of which are herein incorporated by reference.

### TECHNICAL FIELD

The present inventive concepts relate to storage fields, and more particularly, relate to methods and devices for reducing write amplification of storage apparatuses.

### BACKGROUND

Recently, various storage apparatuses (e.g., Universal Flash Storage) have been widely used in various electronic devices. Flash-Friendly File System (F2FS) is a file system developed for NAND flash memory storage apparatuses in the Android operating system. In the Android operating system, an application may delete a large amount of data and/or update a large number of database files during running, and F2FS may delay the synchronization of invalidity of data to a storage apparatus such as UFS, so that the storage apparatus may not know which data is invalid in time.

Turbo Write (TW) 1.0 technology may use a single-level cell (SLC) or the like as caches to write data to an SLC high-speed storage portion of a storage apparatus to improve write performance of the storage apparatus, and when the storage apparatus is ready to sleep, the data may be migrated to the low-speed storage portion such as a Triple-Level Cell (TLC) and/or a Quad-Level Cell (QLC) and/or the like of the storage apparatus.

The application may perform data deletion and modification during running, and the F2FS file system may delay the synchronization of the invalidity of data to the storage apparatus, and TW 1.0 may migrate the data in the SLC to TLC and/or QLC in the sleep state. Accordingly, the F2FS file system may migrate false valid data to TLC and/or QLC, reducing TLC and/or QLC lifespans, and increasing a garbage cleanup overhead.

### SUMMARY

According to some example embodiments of the present inventive concepts, there is provided a methods for reducing write amplification of a storage apparatus, including monitoring a running status of at least one application including a first application; acquiring historical write data of the first application from an application history record to estimate a storage space for current foreground running of the first application based on monitoring the running status of the first application among the at least one application switching to foreground running; determining a storage apparatus adjustment command based on the estimated storage space for the current foreground running of the first application, the storage apparatus including a high-speed storage portion and a low-speed storage portion, the storage apparatus adjustment command including adjustments to a storage space of a variable area in the high-speed storage portion, and the storage apparatus configured to store data generated in response to the at least one application running in the variable area.

The method for reducing the write amplification of the storage apparatus may further include counting and adding running time and writing amount of the first application to the application history record in response to monitoring the running status of the first application among the at least one application being switched to the foreground running.

The acquiring the historical write data of the first application from the application history record to estimate the storage space for the current foreground running of the first application may include estimating the storage space for the current foreground running of the first application based on the historical write data of the first application in response to the historical write data of the first application being acquired from the application history record; and estimating the storage space for the current foreground running of the first application based on historical write data of the at least one application in response to the historical write data of the first application not being acquired from the application history record.

The determining the storage apparatus adjustment command based on the estimated storage space for the current foreground running of the first application may include comparing the storage space for the current foreground running of the first application to a storage space for a last foreground running of the first application.

The comparing the storage space for the current foreground running of the first application to the storage space for the last foreground running of the first application may include determining the storage apparatus adjustment command as performing adjustment based on the estimated storage space for the current foreground running of the first application in response to the estimated storage space for the current foreground running of the first application being less than a first ratio of the storage space for the last foreground running of the first application or greater than a second ratio of the storage space for the last foreground running of the first application, determining the storage apparatus adjustment command as not performing the adjustment in response to the estimated storage space for the current foreground running of the first application being not less than the first ratio of the storage space for the last foreground running of the first application and not greater than the second ratio of the storage space for the last foreground running of the first application, and the first ratio is less than the second ratio.

The method for reducing the write amplification of the storage apparatus may further include determining whether the storage apparatus adjustment command exceeds a storage space of the storage apparatus; and determining the storage apparatus adjustment command as not performing the adjustment or as adjusting an entire high-speed storage portion to be the variable area in response to the storage apparatus adjustment command exceeding the storage space of the storage apparatus.

The method for reducing the write amplification of the storage apparatus may further include transmitting the storage apparatus adjustment command to the storage apparatus to adjust a storage space of the variable area.

The method for reducing the write amplification of the storage apparatus may further include monitoring an available storage space of the variable area, and based on the available storage space being less than a threshold, migrating data in the variable area to the low-speed storage portion.

The method for reducing the write amplification of the storage apparatus may further include counting running time of a second application based on monitoring that a running status of the second application among the at least one application being switched to background running; flagging invalid data in the variable area in response to the running time of the second application exceeding a threshold time, and generating a data synchronization status command based on the flagged invalid data; and migrating data other than the invalid data in the variable area to the low-speed storage portion based on the data synchronization status command.

The storage apparatus may include a Turbo Write 2.0 Universal Flash Storage (TW 2.0 UFS).

According to some example embodiments of the present inventive concepts, there provides a device for reducing write amplification of a storage apparatus, including an application monitoring module configured to monitor a running status of at least one application including a first application; a prediction module configured to acquire historical write data of the first application from an application history record to estimate a storage space for current foreground running of the first application based on monitoring that the running status of the first application among the at least one application being switched to foreground running; a variable area size control module configured to determine a storage apparatus adjustment command based on the estimated storage space for the current foreground running of the first application, the storage apparatus including a high-speed storage portion and a low-speed storage portion, the storage apparatus adjustment command including adjustments to a storage space of a variable area in the high-speed storage portion, and the storage apparatus configured to store data generated in response to the at least one application running in the variable area.

The device for reducing the write amplification of the storage apparatus may further include an application history record module configured to count and add running time and writing amount of the first application to the application history record in response to monitoring that the running status of the first application among the at least one application is switched to the foreground running.

The prediction module may be further configured to estimate the storage space for the current foreground running of the first application based on the historical write data of the first application in response to the historical write data of the first application being acquired from the application history record; and estimate the storage space for the current foreground running of the first application based on historical write data of the at least one application in response to the historical write data of the first application not being acquired from the application history record.

The variable area size control module may be further configured to compare the storage space for the current foreground running of the first application to a storage space for last foreground running of the first application.

The variable area size control module may be further configured to determine the storage apparatus adjustment command as performing adjustment based on the estimated storage space for the current foreground running of the first application based on the estimated storage space for the current foreground running of the first application being less than a first ratio of the storage space for the last foreground running of the first application or greater than a second ratio of the storage space for the last foreground running of the first application, and determine the storage apparatus adjustment command as not performing the adjustment based on the estimated storage space for the current foreground running of the first application being not less than the first ratio of the storage space for the last foreground running of the first application and not greater than the second ratio of the storage space for the last foreground running of the first application, and the first ratio is less than the second ratio.

The device for reducing the write amplification of the storage apparatus may further include a space adjustment monitoring module configured to determine whether the storage apparatus adjustment command exceeds a storage space of the storage apparatus; and determine the storage apparatus adjustment command as not performing the adjustment or as adjusting an entire high-speed storage portion to be the variable area in response to the storage apparatus adjustment command exceeding the storage space of the storage apparatus.

The device for reducing the write amplification of the storage apparatus may further include a space management module configured to transmit the storage apparatus adjustment command to the storage apparatus to adjust a storage space of the variable area.

The space management module may be further configured to monitor an available storage space of the variable area, and based on the available storage space being less than a threshold, migrate data in the variable area to the low-speed storage portion.

The application monitoring module may be further configured to count running time of a second application based on monitoring that a running status of the second application among the at least one application being switched to background running, and, the device for reducing the write amplification of the storage apparatus may further include an application data cleanup module configured to flag invalid data in the variable area in response to the running time of the second application exceeding a threshold time, and generate a data synchronization status command based on the flagged invalid data, and a cleanup control module configured to migrate data other than the invalid data in the variable area to the low-speed storage portion based on the data synchronization status command.

The storage apparatus may include a Turbo Write 2.0 Universal Flash Storage (TW 2.0 UFS).

According to another example embodiment of the present disclosure, there is provided an electronic apparatus, including a memory and a processor, the memory storing computer-executable instructions which, based on being executed by the processor, execute the aforementioned method.

According to another example embodiment of the present inventive concepts, there is provided a non-transitory computer-readable medium having stored thereon computer-executable instructions which, based on being executed by a processor, cause an apparatus including the processor to perform the aforementioned method.

According to some example embodiments of the present inventive concepts, the storage space of the variable area is adjusted by estimating the storage space for the foreground running of the application in real time, so that the variable area may be used more effectively; in addition, by flagging the invalid data in the variable area and migrating the data based on this, the overhead for write amplification and garbage collection of the storage apparatus may be reduced, power consumption of the storage apparatus may be reduced, and a lifespan of the storage apparatus may be prolonged.

### BRIEF DESCRIPTION OF DRAWINGS

The above and other purposes and features of the present inventive concepts will become more apparent from the following detailed descriptions, taken in conjunction with the accompanying drawings in which:

FIG. 1 is a flowchart diagram illustrating a method for reducing write amplification of a storage apparatus according to some example embodiments of the present inventive concepts;

FIG. 2 is a block diagram illustrating a device for reducing write amplification of a storage apparatus according to some example embodiments of the present inventive concepts;

FIG. 3 is a schematic diagram illustrating adjustment process of a storage space of a predetermined variable area according to some example embodiments of the present inventive concepts;

FIG. 4 is a schematic diagram illustrating flow process of application data cleanup according to some example embodiments of the present inventive concepts;

FIG. 5 is a schematic diagram illustrating a state of a device for reducing write amplification of a storage apparatus according to some example embodiments of the present inventive concepts;

FIG. 6 is a schematic diagram illustrating a system to which a storage device is applied according to some example embodiments of the present inventive concepts;

FIG. 7 is a block diagram illustrating a host storage system according to some example embodiments of the present inventive concepts; and

FIG. 8 is a diagram illustrating a data center to which a storage device is applied according to some example embodiments of the present inventive concepts.

### DETAILED DESCRIPTION

Hereinafter, various example embodiments of the present inventive concepts are described with reference to the accompanying drawings, in which the same reference numerals are used to depict the same or similar elements, features, and structures. However, the present inventive concepts are not intended to be limited by the various example embodiments described herein to a specific embodiment and it is intended that the present inventive concepts covers all modifications, equivalents, and/or alternatives of the present inventive concepts, provided they come within the scope of the appended claims and their equivalents. The terms and words used in the following description and claims are not limited to their dictionary meanings, but, are merely used to enable a clear and consistent understanding of the present inventive concepts. Accordingly, it should be apparent to those skilled in the art that the following descriptions of various example embodiments of the present inventive concepts are provided for illustration purpose only and not for the purpose of limiting the present inventive concepts as defined by the appended claims and their equivalents.

It is to be understood that the singular forms include plural forms, unless the context clearly indicates otherwise. The terms “include”, “contain”, and “have”, used herein, indicate functions, operations, or the existence of elements of the inventive concepts, but do not exclude other functions, operations, or elements.

For example, the expressions “A or B”, or “at least one of A and/or B” may indicate A and B, and A or B. For example, the expression “A or B” or “at least one of A and/or B” may indicate (1) A, (2) B, or (3) both A and B.

In various example embodiments of the present inventive concepts, it is intended that when a component (for example, a first component) is referred to as being “coupled” or “connected” with/to another component (for example, a second component), the component may be directly connected to the another component or may be connected through another component (for example, a third component). In contrast, when a component (for example, a first component) is referred to as being “directly coupled” or “directly connected” with/to another component (for example, a second component), another component (for example, a third component) does not exist between the component and the another component.

The expression “configured to”, used in describing various example embodiments of the present inventive concepts, may be used interchangeably with expressions such as “suitable for”, “having the capacity to . . . ”, “designed to”, “adapted to”, “made to”, and “capable of”, for example, according to the situation. The term “configured to” may not necessarily indicate “specifically designed to” in terms of hardware. Instead, the expression “a device configured to . . . ” in some situations may indicate that the device and another device or part are “capable of . . . ”. For example, the expression “a processor configured to perform A, B, and C” may indicate a dedicated processor (for example, an embedded processor) for performing a corresponding operation or a general purpose processor (for example, a central processing unit (CPU) or an application processor (AP)) for performing corresponding operations by executing at least one software program stored in a memory device.

The expression “predetermined”, used in describing various example embodiments of the present inventive concepts, may be used interchangeably with expressions such “desired”, “selected”, “determined”, or “generated” for example, according to the situation.

The terms used herein are to describe some example embodiments of the present inventive concepts, but are not intended to limit the scope of other embodiments. Unless otherwise indicated herein, all terms used herein, including technical or scientific terms, may have the same meanings that are generally understood by a person skilled in the art. In general, terms defined in a dictionary should be considered to have the same meanings as the contextual meanings in the related art, and, unless clearly defined herein, should not be understood differently or as having an excessively formal meaning. In any case, even terms defined in the present inventive concepts are not intended to be interpreted as excluding the example embodiments of the present inventive concepts.

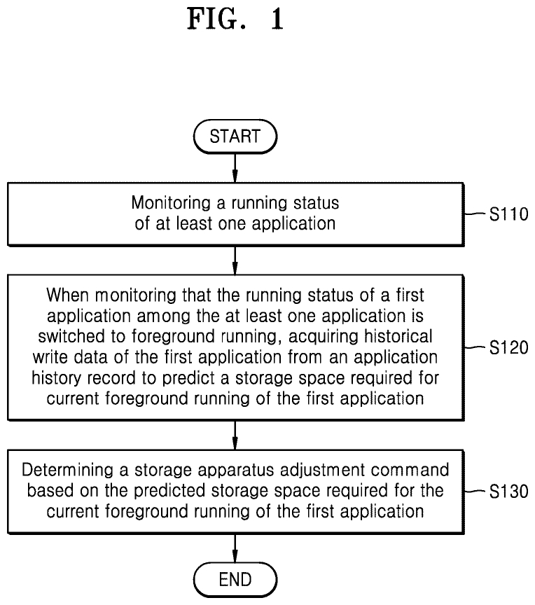

FIG. 1 is a flowchart diagram illustrating a method for reducing write amplification of a storage apparatus according to some example embodiments of the present inventive concepts.

Referring to FIG. 1, in step S110, a running status of at least one application may be monitored. According to some example embodiments of the present inventive concepts, the applications may be applications in operating systems such as an Android operating system or the like, and the running status of the application may be a foreground running application, a background running application, an application foreground and background running switch, etc. In addition, the running status of the at least one application may be monitored by monitoring a broadcast transmitted by the operating system. More particularly, an application name, a process ID (PID) and a child process ID (CPID) of the monitored application may be obtained from the broadcast.

In step S120, when monitoring that the running status of a first application among the at least one application is switched to foreground running, historical write data of the first application may be acquired from an application history record to predict (or, for example, estimate) a storage space (for example, that is desired or required) for current foreground running of the first application.

More specifically, according to some example embodiments of the present inventive concepts, the acquiring the historical write data of the first application from the application history record to predict the storage space required for the current foreground running of the first application may include in the case where the historical write data of the first application is acquired from the application history record, predicting the storage space required for the current foreground running of the first application based on the historical write data of the first application; and in the case where the historical write data of the first application is not acquired from the application history record, predicting the storage space required for the current foreground running of the first application based on historical write data of the at least one application. The storage space may refer to a size or an amount of memory or the like, and, for example, the predicted or estimated storage space may refer to a predicted or estimated amount of memory the current foreground running of the first application may be used (or, for example, that is desired or required for use).

For example, in the case where the historical write data of the first application is acquired from the application history record, the storage space required for the current foreground running of the first application may be predicted using for example a multiple linear regression method. For example, a multiple linear regression model, which may be a linear function of one variable, may be acquired based on the historical write data of the first application (each foreground running time and a corresponding writing amount of the first application), subsequently, a foreground running time median of the first application may be acquired based on the historical write data of the first application, for example, if the number of items in a sequence (wherein, the items in the sequence are arranged by size) composed of all the foreground running times of the first application is odd, a foreground running time in the middle of the sequence may be taken as the median, and if the number of the items in the sequence (wherein, the items in the sequence are arranged by size) composed of all the foreground running times of the first application is even, an average of two foreground running times in the middle of the sequence may be taken as the median. Subsequently, the median of the foreground running times may be plugged in the multiple linear regression model to predict the storage space required for the current foreground running of the first application. In addition, in the case where the historical write data of the first application is acquired from the application history record, predicting the storage space required for the current foreground running of the first application using the multiple linear regression method is only for example purposes rather than limitation, for example, the storage space required for the current foreground running of the first application may also be predicted using a clustering algorithm, etc.

For example, in the case where the historical write data of the first application is not acquired from the application history record, a writing amount median per minute Wm_{0.5} and a foreground running time median Tm_{0.5} of the at least one application may be acquired based on the historical write data of the at least one application, and subsequently, the storage space required for the current foreground running of the first application is predicted based on the writing amount median Wm_{0.5} per minute and the foreground running time median Tm_{0.5} of the at least one application, APw=Wm_{0.5}×Tm_{0.5}. For example, for each application among the at least one application, each foreground running time and the corresponding writing amount of the application may be acquired based on the historical write data of the application, and subsequently, an average writing amount per minute of the application may be acquired by dividing a sum of all the writing amounts of the application by a sum of all the foreground running times of the application. Next, after the average writing amount per minute of each application among the at least one application is obtained, a writing amount median per minute Wm_{0.5} may be acquired based on the average writing amount per minute, for example, if the number of items in a sequence (wherein, the items in the sequence are arranged by size) composed of all the average writing amounts per minute is odd, an average writing amount per minute in the middle of the sequence may be taken as the median, and if the number of items in the sequence (wherein, the items in the sequence are arranged by size) composed of all the average writing amounts per minute is even, an average of two average writing amounts per minute in the middle of the sequence may be taken as the median. In addition, the foreground running time median Tm_{0.5} may be acquired based on each foreground running time of each application among the at least one application, for example, if the number of items in a sequence (wherein, the items in the sequence are arranged by size) composed of all the foreground running times of the at least one application is odd, a foreground running time in the middle of the sequence may be taken as the median, and if the number of the items in the sequence (wherein, the items in the sequence are arranged by size) composed of all the foreground running times of the at least one application is even, an average of two foreground running times in the middle of the sequence may be taken as the median. Subsequently, the storage space required for the current foreground running of the first application may be predicted by multiplying Wm_{0.5} and Tm_{0.5}.

In addition, according to some example embodiments of the present inventive concepts, when monitoring that the running status of the first application among the at least one application is switched to the foreground running, running time and writing amount of the first application may be counted and added to the application history record. According to some example embodiments of the present inventive concepts, the application and a process and a child progress thereof may be identified according to the acquired application name, PID and CPID of the application, and further the running time and the writing amount of the application may be counted. More specifically, the writing amount per minute Aw₁˜Awₙ (wherein, n is running minutes) and the foreground running time At of the application may be counted via various applications or interfaces (such as a systrace, a ftrace, etc. in the Android operating system). Subsequently, the statistical data may be encrypted and stored.

In addition, according to some example embodiments of the present inventive concepts, when monitoring that a running status of a second application among the at least one application is switched to background running, running time of the second application may be counted; in the case where the running time of the second application exceeds a predetermined threshold time (such as 1 min, but not limited thereto), invalid data in the predetermined variable area is flagged, and a data synchronization status command is generated based on the flagged invalid data; and data other than the invalid data in the predetermined variable area is migrated to the low-speed storage portion based on the data synchronization status command. For example, the flagging the invalid data in the predetermined variable area may include transmitting a cleanup command (such as a Trim command) to the file system (such as the F2FS file system), and flagging the invalid data in the predetermined variable area through the file system.

In step S130, a storage apparatus adjustment command may be determined based on the predicted storage space required for the current foreground running of the first application. Here, the storage apparatus may include a high-speed storage portion and a low-speed storage portion, the storage apparatus adjustment command may indicate how to adjust a storage space of the predetermined variable area in the high-speed storage portion, and the predetermined variable area may be used for storing data generated when the at least one application is running. For example, the high-speed storage portion may be SLC, and the low-speed storage portion may be TLC and/or QLC. In addition, the predicted storage space required for the current foreground running of the first application may be stored for subsequent use.

More specifically, according to some example embodiments of the present inventive concepts, the determining the storage apparatus adjustment command based on the predicted storage space required for the current foreground running of the first application may include comparing the storage space required for the current foreground running of the first application to a storage space required for last foreground running of the first application. For example, the comparing the storage space required for the current foreground running of the first application to the storage space required for the last foreground running of the first application may include in the case where the predicted storage space required for the current foreground running of the first application is less than a first predetermined ratio of the storage space required for the last foreground running of the first application or greater than a second predetermined ratio of the storage space required for the last foreground running of the first application, determining the storage apparatus adjustment command as performing adjustment based on the predicted storage space required for the current foreground running of the first application, and in the case where the predicted storage space required for the current foreground running of the first application is not less than the first predetermined ratio of the storage space required for the last foreground running of the first application and not greater than the second predetermined ratio of the storage space required for the last foreground running of the first application, determining the storage apparatus adjustment command as not performing adjustment, wherein the first predetermined ratio is less than the second predetermined ratio. For example, only as an example rather than a limitation, in the case where the predicted storage space required for the current foreground running of the first application is less than 80% of the storage space required for the last foreground running of the first application or greater than 110% of the storage space required for the last foreground running of the first application, the storage apparatus adjustment command for adjusting the storage apparatus is determined. Here, determining whether the predicted storage space required for the current foreground running of the first application is greater than or not greater than the first predetermined ratio and the second predetermined ratio to further perform the adjustment aims to avoid frequent adjustments.

In addition, according to some example embodiments of the present inventive concepts, the method for reducing write amplification of the storage apparatus may further include determining whether the storage apparatus adjustment command exceeds a storage space of the storage apparatus; and in the case where the storage apparatus adjustment command exceeds the storage space of the storage apparatus, determining the storage apparatus adjustment command as not performing the adjustment or as adjusting the entire high-speed storage portion to be the predetermined variable area.

In addition, according to some example embodiments of the present inventive concepts, the method for reducing write amplification of the storage apparatus may further include monitoring an available storage space of the predetermined variable area, and if the available storage space is less than a predetermined threshold (e.g., 90% of the predetermined variable area), migrating data in the predetermined variable area to the low-speed storage portion.

After the step S130, the storage apparatus adjustment command may be transmitted to the storage apparatus to adjust a storage space of the predetermined variable area.

According to some example embodiments of the present inventive concepts, the storage apparatus may include a TW 2.0 UFS, but is not limited hereto, and the storage apparatus may be any storage apparatus that satisfies following conditions including a high-speed storage portion and a low-speed storage portion, and the high-speed storage portion including a predetermined variable area of which a storage space is adjustable.

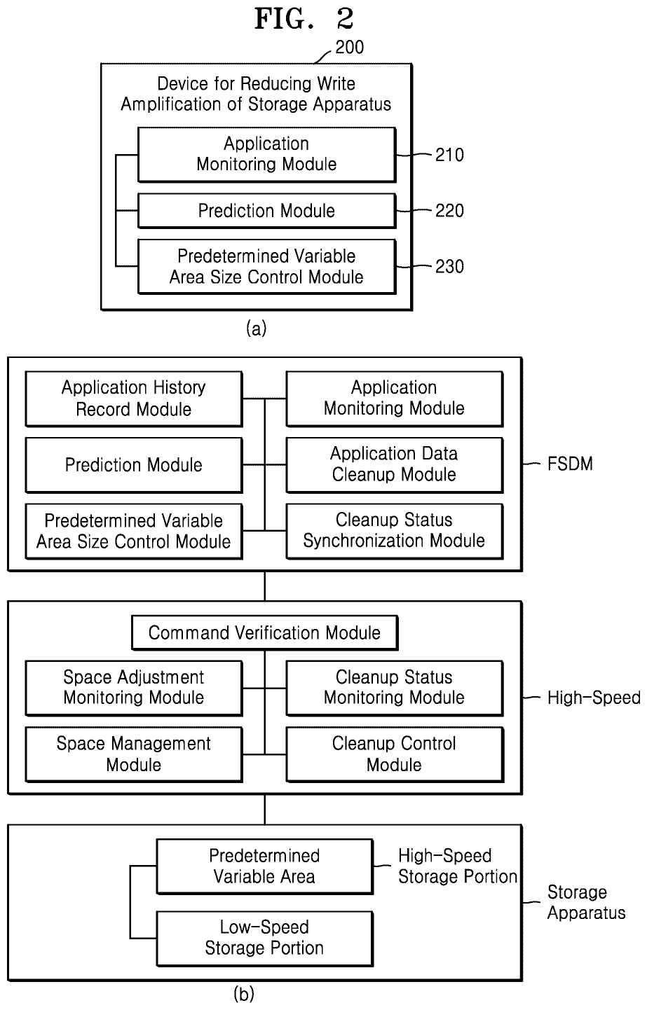

FIG. 2 is a block diagram illustrating a device for reducing write amplification of a storage apparatus according to some example embodiments of the present inventive concepts.

Referring to (a) of FIG. 2, the device 200 for reducing the write amplification of the storage apparatus according to the example embodiment of the present inventive concepts may include an application monitoring module 210, a prediction module 220 and a predetermined variable area size control module 230.

The application monitoring module 210 may be configured to monitor a running status of at least one application.

The prediction module 220 may be configured to, when monitoring that the running status of a first application among the at least one application is switched to foreground running, acquire historical write data of the first application from an application history record to predict a storage space required for current foreground running of the first application.

In addition, the prediction module 220 may be further configured to predict the storage space required for the current foreground running of the first application based on the historical write data of the first application, in the case where the historical write data of the first application is acquired from the application history record; and predict the storage space required for the current foreground running of the first application based on historical write data of the at least one application, in the case where the historical write data of the first application is not acquired from the application history record.

The predetermined variable area size control module 230 may be configured to determine a storage apparatus adjustment command based on the predicted storage space required for the current foreground running of the first application, wherein the storage apparatus may include a high-speed storage portion and a low-speed storage portion, the storage apparatus adjustment command may indicate how to adjust a storage space of a predetermined variable area in the high-speed storage portion, and the predetermined variable area may be used for storing data generated when the at least one application is running. In addition, the predetermined variable area size control module 230 may further encrypt the storage apparatus adjustment command using a predetermined public key.

In addition, the predetermined variable area size control module 230 may be further configured to compare the storage space required for the current foreground running of the first application to a storage space required for last foreground running of the first application.

In addition, the predetermined variable area size control module may be further configured to in the case where the predicted storage space required for the current foreground running of the first application is less than a first predetermined ratio of the storage space required for the last foreground running of the first application or greater than a second predetermined ratio of the storage space required for the last foreground running of the first application, determine the storage apparatus adjustment command as performing adjustment based on the predicted storage space required for the current foreground running of the first application, and in the case where the predicted storage space required for the current foreground running of the first application is not less than the first predetermined ratio of the storage space required for the last foreground running of the first application and not greater than the second predetermined ratio of the storage space required for the last foreground running of the first application, determine the storage apparatus adjustment command as not performing adjustment, wherein the first predetermined ratio is less than the second predetermined ratio.

According to some example embodiments of the present inventive concepts, the device 200 for reducing write amplification of the storage apparatus may further include an application history record module, which may be configured to, when monitoring that the running status of the first application among the at least one application is switched to the foreground running, count and add running time and writing amount of the first application to the application history record. Here, data counted by the application history record module may be encrypted to protect the user privacy.

According to some example embodiments of the present inventive concepts, the device 200 for reducing write amplification of the storage apparatus may further include a space adjustment monitoring module, which may be configured to determine whether the storage apparatus adjustment command exceeds a storage space of the storage apparatus; and in the case where the storage apparatus adjustment command exceeds the storage space of the storage apparatus, determine the storage apparatus adjustment command as not performing the adjustment or as adjusting the entire high-speed storage portion to be the predetermined variable area.

According to some example embodiments of the present inventive concepts, the device 200 for reducing write amplification of the storage apparatus may further include a space management module configured to transmit the storage apparatus adjustment command to the storage apparatus to adjust a storage space of the predetermined variable area. In addition, the space management module may be further configured to monitor an available storage space of the predetermined variable area, and if the available storage space is less than a predetermined threshold, migrate data in the predetermined variable area to the low-speed storage portion.

According to some example embodiments of the present inventive concepts, the application monitoring module 210 may be further configured to, when monitoring that a running status of a second application among the at least one application is switched to background running, count running time of the second application. In this case, the device 200 for reducing the write amplification of the storage apparatus may further include an application data cleanup module configured to, in the case where the running time of the second application exceeds a predetermined threshold time, flag invalid data in the predetermined variable area, and generate a data synchronization status command based on the flagged invalid data; and a cleanup control module configured to migrate data other than the invalid data in the predetermined variable area to the low-speed storage portion based on the data synchronization status command.

Therefore, the improved devices and methods overcome the deficiencies of the conventional devices and methods of writing or storing data, particularly related to writing or storing target data inside a storage device, while reducing resource consumption (e.g., processing capability, power, bandwidth), improving data accuracy, and resource allocation (e.g., latency).

According to some example embodiments of the present inventive concepts, referring to (b) of FIG. 2, the application monitoring module 210, the prediction module 220, the predetermined variable area size control module 230, the application history record module and the application data cleanup module may form a file system data manager (FSDM), and the space adjustment monitoring module, the space management module, the cleanup status monitoring module and the cleanup control module may form a predetermined variable area SLC manager (PSM), wherein the FSDM may further additionally include a cleanup status synchronization module, which may be used for transmitting and/or synchronizing the data synchronization status command generated by the application data cleanup module to the PSM. The cleanup status synchronization module may further encrypt the data synchronization status command using a predetermined public key. Thus, the PSM may further include a command verification module for verifying legality of the data synchronization status command transmitted and/or synchronized by the cleanup status synchronization module and the storage apparatus adjustment command determined by the predetermined variable area size control module 230 to ensure data security, that is, the command verification module may decrypt the data synchronization status command and the storage apparatus adjustment command using a predetermined private key. In addition, the PSM may further include the cleanup status monitoring module for transmitting the data synchronization status command verified by the command verification module to the cleanup control module for data migration.

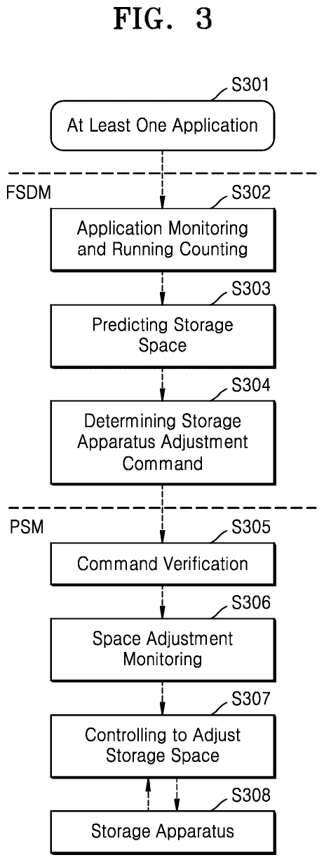

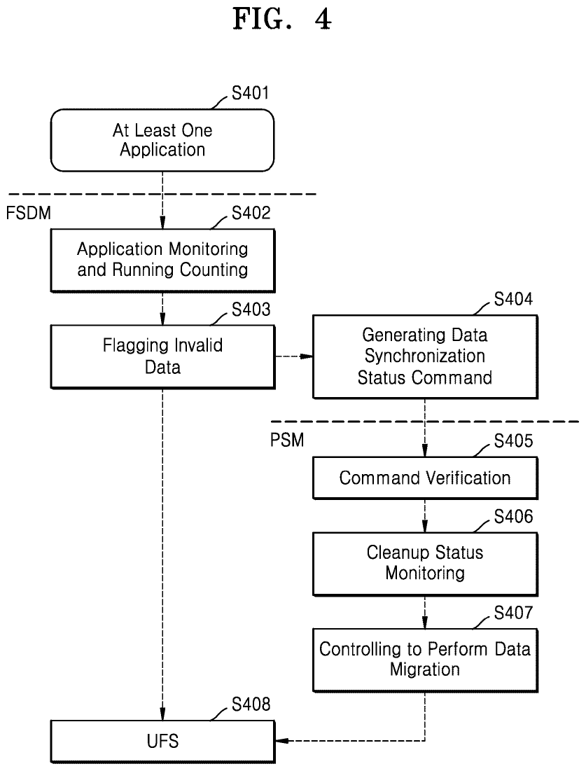

As described above with reference to FIGS. 1 and 2, the method for reducing the write amplification of the storage apparatus according to some example embodiments of the present inventive concepts may include two flowcharts, that is, the adjustment process of the storage space of the predetermined variable area and the cleanup process of the application data, which will be described respectively with reference to FIGS. 3 and 4 below.

FIG. 3 is a schematic diagram illustrating adjustment process of a storage space of a predetermined variable area according to some example embodiments of the present inventive concepts.

Referring to FIG. 3, in FSDM, an application monitoring module, during an operation of at least one application (S301), may monitor a running status of at least one application. The application history record module may, when monitoring that the running status of the first application among the at least one application is switched to the foreground running, count and add running time and writing amount of the first application to the application history record (S302). The prediction module may, when monitoring that the running status of a first application among the at least one application is switched to foreground running, acquire historical write data of the first application from an application history record to predict a storage space required for current foreground running of the first application (S303). The predetermined variable area size control module may compare the predicted storage space required for the current foreground running of the first application to the storage space required for the last foreground running of the first application, and in the case where the predicted storage space required for the current foreground running of the first application is less than a first predetermined ratio of the storage space required for the last foreground running of the first application or greater than a second predetermined ratio of the storage space required for the last foreground running of the first application, determine the storage apparatus adjustment command as performing adjustment based on the predicted required storage space, and encrypt the storage apparatus adjustment command using a predetermined public key to transmit it to the variable area management module (S304).

In the PSM, the command verification module may verify legality of the storage apparatus adjustment command determined by the predetermined variable area size control module to ensure data security, that is, the command verification module may decrypt the storage apparatus adjustment command using a predetermined private key (S305). The space adjustment monitoring module may determine whether the storage apparatus adjustment command exceeds the storage space of the storage apparatus, and in the case where the storage apparatus adjustment command exceeds the storage space of the storage apparatus, does not perform the storage apparatus adjustment command adjustment or adjusts the entire high-speed storage portion to be the predetermined variable area (S306). The space management module may transmit the storage apparatus adjustment command to the storage apparatus to adjust a storage space of the predetermined variable area (S307). In addition, the space management module may monitor an available storage space of the predetermined variable area, and if the available storage space is less than a predetermined threshold, migrate data in the predetermined variable area to the low-speed storage portion for storage (S308).

FIG. 4 is a schematic diagram illustrating flow process of application data cleanup according to some example embodiments of the present inventive concepts.

Referring to FIG. 4, in the FSDM, the application monitoring module, during an operation of at least one application (S401), may, when monitoring that a running status of a second application among the at least one application is switched to background running, count running time of the second application (S402). The application data cleanup module may, in the case where the running time of the second application exceeds a predetermined threshold time, flag invalid data in the predetermined variable area, and generate a data synchronization status command based on the flagged invalid data (S403). The cleanup status synchronization module may transmit and/or synchronize the data synchronization status command generated by the application data cleanup module to the predetermined variable area management module, and the cleanup status synchronization module may further encrypt the data synchronization status command using a predetermined public key (S404).

In the PSM, the command verification module may verify legality of the data synchronization status command transmitted and/or synchronized by the cleanup status synchronization module to ensure data security, that is, the command verification module may decrypt the data synchronization status command using a predetermined private key (S405). The cleanup status monitoring module may transmit the data synchronization status command verified by the command verification module to the cleanup control module for data migration (S406). The cleanup control module may migrate data other than the invalid data in the predetermined variable area to the low-speed storage portion based on the data synchronization status command (S407). The cleanup control module may migrate the data to a universal flash storage (UFS) (S408). In some example embodiments, data not flagged as invalid data may be migrated to the UFS by the application cleanup module (S408).

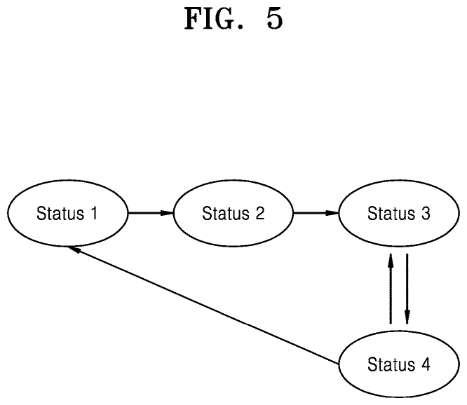

FIG. 5 is a schematic diagram illustrating a state of a device for reducing write amplification of a storage apparatus according to some example embodiments of the present inventive concepts.

As illustrated in FIG. 5, the device for reducing the write amplification of the storage apparatus according to some example embodiments of the present inventive concepts may have following four statuses
Status 1: start initial status, there is no data in the predetermined variable area;
Status 2: a first application is running and data is written to the predetermined variable area;
Status 3: the application is switched;
Status 4: application switching is completed.

More specifically, in Status 1, there is no data in the predetermined variable area;

In Status 2, the first application is prepared to run, the FSDM predicts the storage space required for the running of the first application, the PSM sets the predetermined variable area according to the storage space predicted by the FSDM, the first application is running and writes data (e.g., adds, deletes, updates or the like) to the predetermined variable area (e.g., through a file system).

In Status 3, the first application is not used and is prepared to switch to a second application, the FSDM flags invalid data in the predetermined variable area (e.g., through the file system) and generates a data synchronization status command, the FSDM informs the PSM of the data synchronization status command after the flagging is completed, and the PSM migrates the valid data in the predetermined variable area to the low-speed storage portion according to the data synchronization status command.

In Status 4, the FSDM predicts the storage space required for the running of the second application, the PSM re-sets the predetermined variable area according to the storage space predicted by the FSDM, the second application is running and writes data (e.g., adds, deletes, updates or the like) to the predetermined variable area (through the file system).

In addition, as illustrated in FIG. 5, the above several statuses may be converted according to arrows.

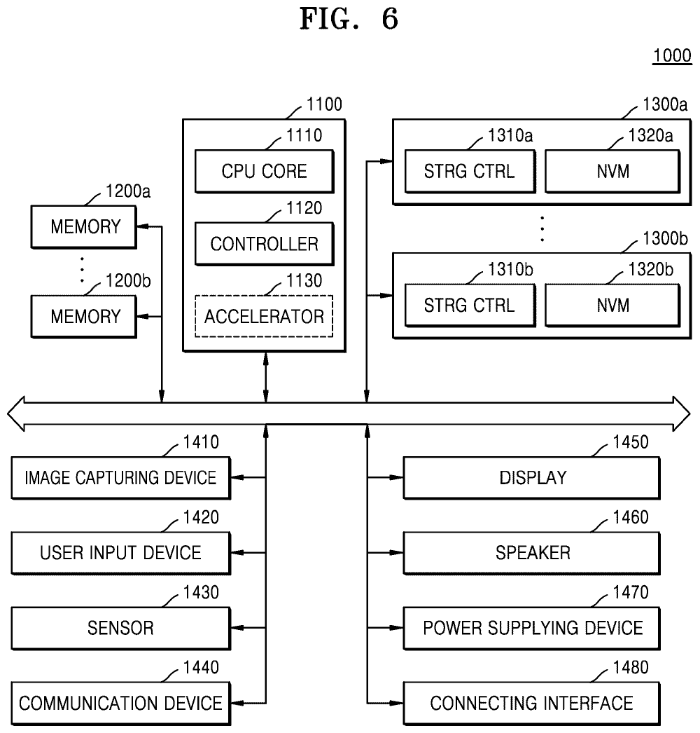

FIG. 6 is a schematic diagram illustrating a system 1000 to which a storage device is applied according to some example embodiments of the present inventive concepts.

The system 1000 of FIG. 6 may basically be a mobile system, such as a portable communication terminal (e.g., a mobile phone), a smartphone, a tablet personal computer (PC), a wearable device, a healthcare device, or an Internet of things (IOT) device. However, the system 1000 of FIG. 6 is not necessarily limited to the mobile system and may be a PC, a laptop computer, a server, a media player, or an automotive device (e.g., a navigation device).

Referring to FIG. 6, the system 1000 may include a main processor 1100, memories (e.g., 1200a and 1200b), and storage devices (e.g., 1300a and 1300b). In addition, the system 1000 may include at least one of an image capturing device 1410, a user input device 1420, a sensor 1430, a communication device 1440, a display 1450, a speaker 1460, a power supplying device 1470, and a connecting interface 1480.

The main processor 1100 may control all operations of the system 1000, more specifically, operations of other components included in the system 1000. The main processor 1100 may be implemented as a general-purpose processor, a dedicated processor, or an application processor.

The main processor 1100 may include at least one CPU core 1110 and further include a controller 1120 configured to control the memories 1200a and 1200b and/or the storage devices 1300a and 1300b. In some example embodiments, the main processor 1100 may further include an accelerator 1130, which is a dedicated circuit for a high-speed data operation, such as an artificial intelligence (AI) data operation. The accelerator 1130 may include a graphics processing unit (GPU), a neural processing unit (NPU) and/or a data processing unit (DPU) and be implemented as a chip that is physically separate from the other components of the main processor 1100.

The memories 1200a and 1200b may be used as main memory devices of the system 1000. Although each of the memories 1200a and 1200b may include a volatile memory, such as static random access memory (SRAM) and/or dynamic RAM (DRAM), each of the memories 1200a and 1200b may include non-volatile memory, such as a flash memory, phase-change RAM (PRAM) and/or resistive RAM (RRAM). The memories 1200a and 1200b may be implemented in the same package as the main processor 1100.

The storage devices 1300a and 1300b may serve as non-volatile storage devices configured to store data regardless of whether power is supplied thereto, and have larger storage capacity than the memories 1200a and 1200b. The storage devices 1300a and 1300b may respectively include storage controllers (STRG CTRL) 1310a and 1310b and NVM (Non-Volatile Memory) s 1320a and 1320b configured to store data via the control of the storage controllers 1310a and 1310b. Although the NVMs 1320a and 1320b may include flash memories having a two-dimensional (2D) structure or a three-dimensional (3D) V-NAND structure, the NVMs 1320a and 1320b may include other types of NVMs, such as PRAM and/or RRAM.

The storage devices 1300a and 1300b may be physically separated from the main processor 1100 and included in the system 1000 or implemented in the same package as the main processor 1100. In addition, the storage devices 1300a and 1300b may have types of solid-state devices (SSDs) or memory cards and be removably combined with other components of the system 100 through an interface, such as the connecting interface 1480 that will be described below. The storage devices 1300a and 1300b may be devices to which a standard protocol, such as a universal flash storage (UFS), an embedded multi-media card (eMMC), or a non-volatile memory express (NVMe), is applied, without being limited thereto.

The image capturing device 1410 may capture still images or moving images. The image capturing device 1410 may include a camera, a camcorder, and/or a webcam.

The user input device 1420 may receive various types of data input by a user of the system 1000 and include a touch pad, a keypad, a keyboard, a mouse, and/or a microphone.

The sensor 1430 may detect various types of physical quantities, which may be obtained from the outside of the system 1000, and convert the detected physical quantities into electric signals. The sensor 1430 may include a temperature sensor, a pressure sensor, an illuminance sensor, a position sensor, an acceleration sensor, a biosensor, and/or a gyroscope sensor.

The communication device 1440 may transmit and receive signals between other devices outside the system 1000 according to various communication protocols. The communication device 1440 may include an antenna, a transceiver, and/or a modem.

The display 1450 and the speaker 1460 may serve as output devices configured to respectively output visual information and auditory information to the user of the system 1000.

The power supplying device 1470 may appropriately convert power supplied from a battery (not shown) embedded in the system 1000 and/or an external power source, and supply the converted power to each of components of the system 1000.

The connecting interface 1480 may provide connection between the system 1000 and an external device, which is connected to the system 1000 and capable of transmitting and receiving data to and from the system 1000. The connecting interface 1480 may be implemented by using various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface.

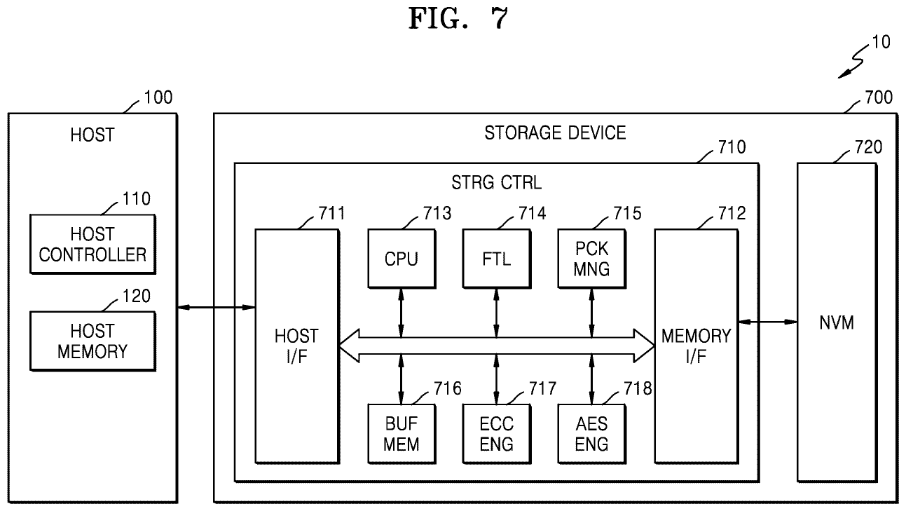

FIG. 7 is a block diagram of a host storage system 10 according to some example embodiments of the present inventive concepts.

The host storage system 10 may include a host 100 and a storage device 700. Further, the storage device 700 may include a storage controller 710 and an NVM 720. According to some example embodiments of the present inventive concepts, the host 100 may include a host controller 110 and a host memory 120. The host memory 120 may serve as a buffer memory configured to temporarily store data to be transmitted to the storage device 700 or data received from the storage device 700.

The storage device 700 may include storage media configured to store data in response to requests from the host 100. As an example, the storage device 700 may include at least one of an SSD, an embedded memory, and a removable external memory. When the storage device 700 is an SSD, the storage device 700 may be a device that conforms to an NVMe standard. When the storage device 700 is an embedded memory or an external memory, the storage device 700 may be a device that conforms to a UFS standard or an eMMC standard. Each of the host 100 and the storage device 700 may generate a packet according to an adopted standard protocol and transmit the packet.

When the NVM 720 of the storage device 700 includes a flash memory, the flash memory may include a 2D NAND memory array or a 3D (or vertical) NAND (VNAND) memory array. As another example, the storage device 700 may include various other kinds of NVMs. For example, the storage device 700 may include magnetic RAM (MRAM), spin-transfer torque MRAM, conductive bridging RAM (CBRAM), ferroelectric RAM (FRAM), PRAM, RRAM, and various other kinds of memories.

According to an embodiment, the host controller 110 and the host memory 120 may be implemented as separate semiconductor chips. Alternatively, in some embodiments, the host controller 110 and the host memory 120 may be integrated in the same semiconductor chip. As an example, the host controller 110 may be any one of a plurality of modules included in an application processor (AP). The AP may be implemented as a System on Chip (SoC). Further, the host memory 120 may be an embedded memory included in the AP or an NVM or memory module located outside the AP.

The host controller 110 may manage an operation of storing data (e.g., write data) of a buffer region of the host memory 120 in the NVM 720 or an operation of storing data (e.g., read data) of the NVM 720 in the buffer region.

The storage controller 710 may include a host interface 711, a memory interface 712, and a CPU 713. Further, the storage controllers 710 may further include a flash translation layer (FTL) 714, a packet manager 715, a buffer memory 716, an error correction code (ECC) engine 717, and an advanced encryption standard (AES) engine 718. The storage controllers 710 may further include a working memory (not shown) in which the FTL 714 is loaded. The CPU 713 may execute the FTL 714 to control data write and read operations on the NVM 720.

The host interface 711 may transmit and receive packets to and from the host 100. A packet transmitted from the host 100 to the host interface 711 may include a command or data to be written to the NVM 720. A packet transmitted from the host interface 711 to the host 100 may include a response to the command or data read from the NVM 720. The memory interface 712 may transmit data to be written to the NVM 720 or receive data read from the NVM 720. The memory interface 712 may be configured to comply with a standard protocol, such as Toggle or open NAND flash interface (ONFI).

The FTL 714 may perform various functions, such as an address mapping operation, a wear-leveling operation, and a garbage collection operation. The address mapping operation may be an operation of converting a logical address received from the host 100 into a physical address used to actually store data in the NVM 720. The wear-leveling operation may be a technique for preventing excessive deterioration of a specific block by allowing blocks of the NVM 720 to be uniformly used. As an example, the wear-leveling operation may be implemented using a firmware technique that balances erase counts of physical blocks. The garbage collection operation may be a technique for ensuring usable capacity in the NVM 720 by erasing an existing block after copying valid data of the existing block to a new block.

The packet manager 715 may generate a packet according to a protocol of an interface, which consents to the host 100, or parse various types of information from the packet received from the host 100. In addition, the buffer memory 716 may temporarily store data to be written to the NVM 720 or data to be read from the NVM 720. Although the buffer memory 716 may be a component included in the storage controllers 710, the buffer memory 716 may be outside the storage controllers 710.

The ECC engine 717 may perform error detection and correction operations on read data read from the NVM 720. More specifically, the ECC engine 717 may generate parity bits for write data to be written to the NVM 720, and the generated parity bits may be stored in the NVM 720 together with write data. During the reading of data from the NVM 720, the ECC engine 717 may correct an error in the read data by using the parity bits read from the NVM 720 along with the read data, and output error-corrected read data.

The AES engine 718 may perform at least one of an encryption operation and a decryption operation on data input to the storage controllers 710 by using a symmetric-key algorithm.

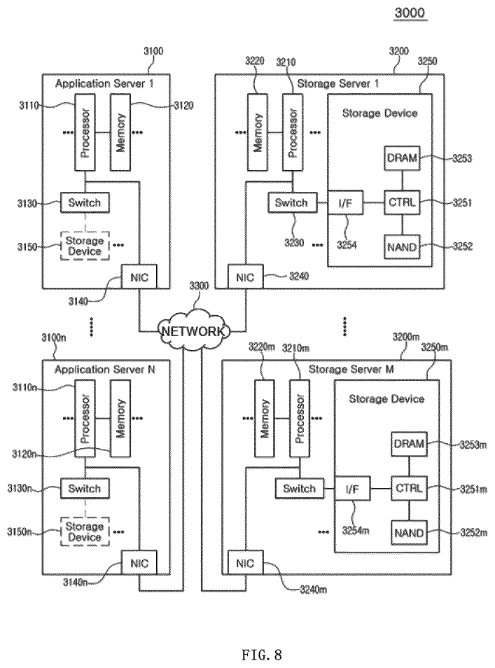

FIG. 8 is a diagram illustrating a data center 3000 to which a storage device is applied according to some example embodiments of the present inventive concepts.

### Platform Portion—Server (Application/Storage)

Referring to FIG. 8, the data center 3000 may be a facility that collects various types of pieces of data and provides services and be referred to as a data storage center. The data center 3000 may be a system for operating a search engine and a database, and may be a computing system used by companies, such as banks, or government agencies. The data center 3000 may include application servers 3100 to 3100n and storage servers 3200 to 3200m. The number of application servers 3100 to 3100n and the number of storage servers 3200 to 3200m may be variously selected according to example embodiments. The number of application servers 3100 to 3100n may be different from the number of storage servers 3200 to 3200m.

The application server 3100 or the storage server 3200 may include at least one of processors 3110 and 3210 and memories 3120 and 3220. The storage server 3200 will now be described as an example. The processor 3210 may control all operations of the storage server 3200, access the memory 3220, and execute instructions and/or data loaded in the memory 3220. The memory 3220 may be a double-data-rate synchronous DRAM (DDR SDRAM), a high-bandwidth memory (HBM), a hybrid memory cube (HMC), a dual in-line memory module (DIMM), Optane DIMM, and/or a non-volatile DIMM (NVMDIMM). In some example embodiments, the numbers of processors 3210 and memories 3220 included in the storage server 3200 may be variously selected. In some example embodiments, the processor 3210 and the memory 3220 may provide a processor-memory pair. In some example embodiments, the number of processors 3210 may be different from the number of memories 3220. The processor 3210 may include a single-core processor or a multi-core processor. The above description of the storage server 3200 may be similarly applied to the application server 3100. In some example embodiments, the application server 3100 may not include a storage device 3150. The storage server 3200 may include at least one storage device 3250. The number of storage devices 3250 included in the storage server 3200 may be variously selected according to embodiments.

### Platform Portion—Network

The application servers 3100 to 3100n may communicate with the storage servers 3200 to 3200m through a network 3300. The network 3300 may be implemented by using a fiber channel (FC) or Ethernet. In this case, the FC may be a medium used for relatively high-speed data transmission and use an optical switch with high performance and high availability. The storage servers 3200 to 3200m may be provided as file storages, block storages, or object storages according to an access method of the network 3300.

In an embodiment, the network 3300 may be a storage-dedicated network, such as a storage area network (SAN). For example, the SAN may be an FC-SAN, which uses an FC network and is implemented according to an FC protocol (FCP). As another example, the SAN may be an Internet protocol (IP)-SAN, which uses a transmission control protocol (TCP)/IP network and is implemented according to a SCSI over TCP/IP or Internet SCSI (iSCSI) protocol. In another embodiment, the network 3300 may be a general network, such as a TCP/IP network. For example, the network 3300 may be implemented according to a protocol, such as FC over Ethernet (FCOE), network attached storage (NAS), and NVMe over Fabrics (NVMe-oF).

Hereinafter, the application server 3100 and the storage server 3200 will mainly be described. A description of the application server 3100 may be applied to another application server 3100n, and a description of the storage server 3200 may be applied to another storage server 3200m.

The application server 3100 may store data, which is requested by a user or a client to be stored, in one of the storage servers 3200 to 3200m through the network 3300. Also, the application server 3100 may obtain data, which is requested by the user or the client to be read, from one of the storage servers 3200 to 3200m through the network 3300. For example, the application server 3100 may be implemented as a web server or a database management system (DBMS).

The application server 3100 may access a memory 3120n or a storage device 3150n, which is included in another application server 3100n, through the network 3300. Alternatively, the application server 3100 may access memories 3220 to 3220m or storage devices 3250 to 3250m, which are included in the storage servers 3200 to 3200m, through the network 3300. Thus, the application server 3100 may perform various operations on data stored in application servers 3100 to 3100n and/or the storage servers 3200 to 3200m. For example, the application server 3100 may execute an instruction for moving or copying data between the application servers 3100 to 3100n and/or the storage servers 3200 to 3200m. In this case, the data may be moved from the storage devices 3250 to 3250m of the storage servers 3200 to 3200m to the memories 3120 to 3120n of the application servers 3100 to 3100n directly or through the memories 3220 to 3220m of the storage servers 3200 to 3200m. The data moved through the network 3300 may be data encrypted for security or privacy.

### Organic Relationship—Interface Structure/Type

The storage server 3200 will now be described as an example. An interface 3254 may provide physical connection between a processor 3210 and a controller 3251 and a physical connection between a network interface card (NIC) 3240 and the controller 3251. For example, the interface 3254 may be implemented using a direct attached storage (DAS) scheme in which the storage device 3250 is directly connected with a dedicated cable. For example, the interface 3254 may be implemented by using various interface schemes, such as ATA, SATA, e-SATA, an SCSI, SAS, PCI, PCIe, NVMe, IEEE 1394, a USB interface, an SD card interface, an MMC interface, an eMMC interface, a UFS interface, an eUFS interface, and/or a CF card interface.

The storage server 3200 may further include a switch 3230 and the NIC (Network InterConnect) 3240. The switch 3230 may selectively connect the processor 3210 to the storage device 3250 or selectively connect the NIC 3240 to the storage device 3250 via the control of the processor 3210.

In an embodiment, the NIC 3240 may include a network interface card and a network adaptor. The NIC 3240 may be connected to the network 3300 by a wired interface, a wireless interface, a Bluetooth interface, or an optical interface. The NIC 3240 may include an internal memory, a digital signal processor (DSP), and a host bus interface and be connected to the processor 3210 and/or the switch 3230 through the host bus interface. The host bus interface may be implemented as one of the above-described examples of the interface 3254. In an embodiment, the NIC 3240 may be integrated with at least one of the processor 3210, the switch 3230, and the storage device 3250.

### Organic Relationship—Interface Operation

In the storage servers 3200 to 3200m or the application servers 3100 to 3100n, a processor may transmit a command to storage devices 3150 to 3150n and 3250 to 3250m or the memories 3120 to 3120n and 3220 to 3220m and program or read data. In this case, the data may be data of which an error is corrected by an ECC engine. The data may be data on which a data bus inversion (DBI) operation or a data masking (DM) operation is performed, and may include cyclic redundancy code (CRC) information. The data may be data encrypted for security or privacy.

Storage devices 3150 to 3150n and 3250 to 3250m may transmit a control signal and a command/address signal to NAND flash memory devices 3252 to 3252m in response to a read command received from the processor. Thus, when data is read from the NAND flash memory devices 3252 to 3252m, a read enable (RE) signal may be input as a data output control signal, and thus, the data may be output to a DQ bus. A data strobe signal DQS may be generated using the RE signal. The command and the address signal may be latched in a page buffer depending on a rising edge or falling edge of a write enable (WE) signal.

### Product Portion—SSD Basic Operation

The controller 3251 may control all operations of the storage device 3250. In an embodiment, the controller 3251 may include SRAM. The controller 3251 may write data to the NAND flash memory device 3252 in response to a write command or read data from the NAND flash memory device 3252 in response to a read command. For example, the write command and/or the read command may be provided from the processor 3210 of the storage server 3200, the processor 3210m of another storage server 3200m, or the processors 3110 and 3110n of the application servers 3100 and 3100n. DRAM 3253 may temporarily store (or buffer) data to be written to the NAND flash memory device 3252 or data read from the NAND flash memory device 3252. Also, the DRAM 3253 may store metadata. Here, the metadata may be user data or data generated by the controller 3251 to manage the NAND flash memory device 3252. The storage device 3250 may include a secure element (SE) for security or privacy. ( [symbol] [symbol] [symbol] [symbol] [symbol] [symbol] )

According to some example embodiments of the present inventive concepts, there provides a computer-readable medium having stored thereon computer executable instructions that, when executed, execute the previously mentioned method. Examples of the computer-readable medium here may include Read Only Memory (ROM), Random Access Programmable Read Only Memory (PROM), Electrically Erasable Programmable Read Only Memory (EEPROM), Random Access Memory (RAM), Dynamic Random Access Memory (DRAM), Static Random Access Memory (SRAM), Flash, Non-Volatile Memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disc storage, hard disk drive (HDD), solid state drive (SSD), card storage (such as, Multimedia Cards, Secure Digital (SD) Cards or Extreme Digital (XD) Cards), magnetic tapes, floppy disks, magneto-optical data storage devices, optical data storage devices, hard disks, solid state disks, and any other device. The any other device is configured to store a computer program and any relevant data, data files and data structures in a non-transitory manner and to provide the computer program and any relevant data, data files and data structures to a processor or computer, so that the processor or computer can execute the computer program. The computer program in the above computer-readable medium may run in an environment deployed in computer devices such as a client, a host, an agent device and a server. In addition, in an example, the computer program and any relevant data, data files and data structures are distributed over networked computer systems, so that the computer program and any relevant data, data files and data structures are stored, accessed and executed in a distributed manner by one or more processors or computers.

According to some example embodiments of the present inventive concepts, the storage space of the predetermined variable area is adjusted by predicting the storage space required for the foreground running of the application in real time, so that the predetermined variable area may be used more effectively; in addition, by flagging the invalid data in the predetermined variable area and migrating the data based on this, the overhead for write amplification and garbage collection of the storage apparatus may be reduced, power consumption of the storage apparatus may be reduced, and a lifespan of the storage apparatus may be prolonged.

As described herein, any electronic devices and/or portions thereof according to any of the example embodiments may include, may be included in, and/or may be implemented by one or more instances of processing circuitry such as hardware including logic circuits; a hardware/software combination such as a processor executing software; or any combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a DRAM device, storing a program of instructions, and a processor (e.g., CPU) configured to execute the program of instructions to implement the functionality and/or methods performed by some or all of any devices, systems, modules, units, controllers, circuits, architectures, and/or portions thereof according to any of the example embodiments, and/or any portions thereof.

Although the present inventive concepts has been illustrated and described with reference to specific example embodiments, it will be understood by those skilled in the art that various changes in form and detail may be made without departing from the spirit and scope of the present inventive concepts as defined by the claims and the equivalents thereof.

1. A method for reducing write amplification of a storage apparatus, comprising:
monitoring a running status of at least one application including a first application;
acquiring, based on the running status of the first application being switched from background running to foreground running, historical write data of the first application from an application history record to estimate a storage space for current foreground running of the first application; and
determining a storage apparatus adjustment command based on the estimated storage space for the current foreground running of the first application,
wherein the storage apparatus includes a high-speed storage portion and a low-speed storage portion, the high-speed storage portion includes a variable area which is used for storing data generated when the at least one application is running, and at least a portion of data in the variable area is migrated to the low-speed storage portion,
wherein the storage apparatus adjustment command includes adjustments to a storage space of the variable area in the high-speed storage portion, and
wherein the storage apparatus is configured to store data generated in response to the at least one application running in the variable area.

2. The method for reducing write amplification of the storage apparatus of claim 1, further comprising:
counting and adding running time and writing amount of the first application to the application history record in response to monitoring the running status of the first application among the at least one application being switched to the foreground running.

3. The method for reducing write amplification of the storage apparatus of claim 1, wherein the acquiring the historical write data of the first application from the application history record to estimate the storage space for the current foreground running of the first application comprises:
estimating the storage space for the current foreground running of the first application based on the historical write data of the first application in response to the historical write data of the first application being acquired from the application history record; and
estimating the storage space for the current foreground running of the first application based on the historical write data of the at least one application in response to the historical write data of the first application not being acquired from the application history record.

4. The method for reducing write amplification of the storage apparatus of claim 1, wherein the determining the storage apparatus adjustment command based on the estimated storage space for the current foreground running of the first application comprises:
comparing the storage space for the current foreground running of the first application to a storage space for a last foreground running of the first application.

5. The method for reducing write amplification of the storage apparatus of claim 4, wherein
the comparing the storage space for the current foreground running of the first application to the storage space for the last foreground running of the first application comprises:
determining the storage apparatus adjustment command as performing adjustment based on the estimated storage space for the current foreground running of the first application in response to the estimated storage space for the current foreground running of the first application being less than a first ratio of the storage space for the last foreground running of the first application or greater than a second ratio of the storage space for the last foreground running of the first application; and
determining the storage apparatus adjustment command as not performing the adjustment in response to the estimated storage space for the current foreground running of the first application being not less than the first ratio of the storage space for the last foreground running of the first application and not greater than the second ratio of the storage space for the last foreground running of the first application, and
the first ratio is less than the second ratio.

6. The method for reducing write amplification of the storage apparatus of claim 1, further comprising:
determining whether the storage apparatus adjustment command exceeds a storage space of the storage apparatus; and
determining the storage apparatus adjustment command as not performing the adjustment or as adjusting an entire high-speed storage portion to be the variable area in response to the storage apparatus adjustment command exceeding the storage space of the storage apparatus.

7. The method for reducing write amplification of the storage apparatus of claim 1, further comprising:
transmitting the storage apparatus adjustment command to the storage apparatus to adjust the storage space of the variable area.

8. The method for reducing write amplification of the storage apparatus of claim 7, further comprising:
monitoring an available storage space of the variable area, and based on the available storage space being less than a threshold, migrating data in the variable area to the low-speed storage portion.

9. The method for reducing write amplification of the storage apparatus of claim 1, further comprising:
counting running time of a second application based on monitoring that a running status of the second application among the at least one application being switched to background running;
flagging invalid data in the variable area in response to the running time of the second application exceeding a threshold time, and generating a data synchronization status command based on the flagged invalid data; and
migrating data other than the invalid data in the variable area to the low-speed storage portion based on the data synchronization status command.

10. The method for reducing write amplification of the storage apparatus of claim 1, wherein the storage apparatus comprises a Turbo Write 2.0 Universal Flash Storage (TW 2.0 UFS).

11. A device for reducing write amplification of a storage apparatus, comprising:
at least one processor configured to execute a file system data manager, the file system data manager comprising:
an application monitoring module configured to monitor, when executed by the at least one processor, a running status of at least one application including a first application;
a prediction module configured to acquire, when executed by the at least one processor and based on the running status of the first application being switched from background running to foreground running, historical write data of the first application from an application history record to estimate a storage space for current foreground running of the first application; and
a variable area size control module configured to determine, when executed by the at least one processor, a storage apparatus adjustment command based on the estimated storage space for the current foreground running of the first application,
the storage apparatus comprising a high-speed storage portion and a low-speed storage portion, the high-speed storage portion includes a variable area which is used for storing data generated when the at least one application is running, and at least a portion of data in the variable area is migrated to the low-speed storage portion,
the storage apparatus adjustment command including adjustments to a storage space of the variable area in the high-speed storage portion, and
the storage apparatus configured to store data generated in response to the at least one application running in the variable area.

12. The device for reducing write amplification of the storage apparatus of claim 11, further comprising:
an application history record module configured to count and add running time and writing amount of the first application to the application history record in response to monitoring that the running status of the first application among the at least one application is switched to the foreground running.

13. The device for reducing write amplification of the storage apparatus of claim 11, wherein the prediction module is further configured to:
estimate the storage space for the current foreground running of the first application based on the historical write data of the first application in response to the historical write data of the first application being acquired from the application history record; and
estimate the storage space for the current foreground running of the first application based on the historical write data of the at least one application in response to the historical write data of the first application not being acquired from the application history record.

14. The device for reducing write amplification of the storage apparatus of claim 11, wherein the variable area size control module is further configured to:
compare the storage space for the current foreground running of the first application to a storage space for last foreground running of the first application.

15. The device for reducing write amplification of the storage apparatus of claim 14, wherein
the variable area size control module is further configured to:
determine the storage apparatus adjustment command as performing adjustment based on the estimated storage space for the current foreground running of the first application based on the estimated storage space for the current foreground running of the first application being less than a first ratio of the storage space for the last foreground running of the first application or greater than a second ratio of the storage space for the last foreground running of the first application; and
determine the storage apparatus adjustment command as not performing the adjustment based on the estimated storage space for the current foreground running of the first application being not less than the first ratio of the storage space for the last foreground running of the first application and not greater than the second ratio of the storage space for the last foreground running of the first application, and
the first ratio is less than the second ratio.

16. The device for reducing write amplification of the storage apparatus of claim 11, further comprising a space adjustment monitoring module configured to
determine whether the storage apparatus adjustment command exceeds a storage space of the storage apparatus; and
determine the storage apparatus adjustment command as not performing the adjustment or as adjusting an entire high-speed storage portion to be the variable area in response to the storage apparatus adjustment command exceeding the storage space of the storage apparatus.

17. The device for reducing write amplification of the storage apparatus of claim 11, further comprising:
a space management module configured to transmit the storage apparatus adjustment command to the storage apparatus to adjust a storage space of the variable area.

18. The device for reducing write amplification of the storage apparatus of claim 17, wherein the space management module is further configured to monitor an available storage space of the variable area, and based on the available storage space being less than a threshold, migrate data in the variable area to the low-speed storage portion.

19. The device for reducing write amplification of the storage apparatus of claim 11, wherein
the application monitoring module is further configured to count running time of a second application based on monitoring that a running status of the second application among the at least one application being switched to background running, and
the device for reducing the write amplification of the storage apparatus further comprises:
an application data cleanup module configured to flag invalid data in the variable area in response to the running time of the second application exceeding a threshold time, and generate a data synchronization status command based on the flagged invalid data; and
a cleanup control module configured to migrate data other than the invalid data in the variable area to the low-speed storage portion based on the data synchronization status command.

20. The device for reducing write amplification of the storage apparatus of claim 11, wherein the storage apparatus comprises a Turbo Write 2.0 Universal Flash Storage (TW 2.0 UFS).

21. (canceled)

22. (canceled)
